(19) United States
(12) Patent Application Publication
(10) Pub. No.: US 2022/0213286 A1
(43) Pub. Date: Jul. 7, 2022

(54) METALLIZED FILM

(71) Applicant: Hueck Folien Gesellschaft m.b.H., Baumgartenberg (AT)

(72) Inventors: Georg AIGNER, Ennsdorf (AT); Waltraud RICKER, Ardagger Markt (AT)

(73) Assignee: Hueck Folien Gesellschaft m.b.H., Baumgartenberg (AT)

(21) Appl. No.: 17/605,677

(22) PCT Filed: Apr. 28, 2020
(86) PCT No.: PCT/EP2020/061777

§ 371 Date: Oct. 22, 2021

(30) Foreign Application Priority Data
May 2, 2019 (EP) 19172277.6

(51) Int. Cl. C08J 7/04; C08J 5/18; C08J 3/24; C08J 7/043; C08L 23/06

(52) U.S. Cl. CPC C08J 7/0423; C08J 5/18; C08J 3/24; C08J 7/043; C08J 2475/04; C08J 2323/06; C08L 2203/16; C08J 2467/00; C08L 23/06

(57) ABSTRACT

The invention relates to a metallized film, in particular a metallized plastic film, which comprises a metallic layer on at least one surface, characterized in that it comprises the following layers in the indicated order:
a) a carrier substrate of a plastic film
b) a lacquer layer as an adhesion promoter layer
c) a metallic layer applied, in particular directly, to the lacquer layer
d) optionally a cover layer.

The invention relates to a metallized film, in particular a metallized plastic film, which comprises a metallic layer on at least one surface.

Moreover, the invention relates to a method for producing a metallized film.

The application of decorative layers, in particular also the application of metallic decorative layers to a carrier, a carrier film or an object is usually carried out by transferring the layers from a transfer film to the carrier or object. This transfer process is in particular used when polyethylene films are used as carriers, since polyethylene makes direct specular metallization very difficult due to its physical properties, such as temperature resistance, low glass transition temperature Tg and the like. The transfer film consists of a carrier substrate onto which the decorative layer(s) is/are applied. After the transfer of the decorative layer(s), the carrier substrate of the transfer film may be removed.

The disadvantage of this type of application of decorative, in particular metallic layers, is that the adhesion of the layer(s) to the carrier is often bad or insufficient and, above all, a subsequent printing of the decorative layer(s) is difficult. Thus, after the transfer has been carried out, an additional printing primer must obligatorily be applied to enable sufficient printability.

A decorative foil for application on any carriers, which consists of a polymeric carrier film, which is provided with a metallic layer and/or a printing and at least one protective lacquer layer, is known from WO 2007/054343 A2.

A decorative laminate having high reflectance and brilliance is known from U.S. Pat. No. 4,403,004. The laminate comprises a base layer prepared from a thermo-formable resin film, with both surfaces thereof coated with a thin, adhering metal layer produced in a PVD process. A protective layer is bonded to one of the metallized surface of the base layer. An elastomeric adhesive coating sensitive to pressure and heat, which is insensitive against ultraviolet radiation and harmless to the metal layers, is located between the protective layer and the metallized surface of the base layer.

It was the object of the present invention to provide a direct metallized film having a highly polished, reflecting surface and is printable and may be used in particular for flexible products, such as label film.

The aforementioned object is achieved according to the invention with a film of the initially mentioned type in that it comprises the following layers in the indicated order
a) a carrier substrate of a plastic film
b) a lacquer layer as an adhesion promoter layer
c) a metallic layer applied, in particular directly, to the lacquer layer
d) optionally a cover layer.

The solution according to the invention allows the realization of a metallized film having very good mirror optics and being particularly suitable for flexible label films.

As carrier substrates, for example, preferably transparent carrier films, preferably flexible plastic films, for example made of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK) polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF) and ethylene-tetrafluoroethylene-hexafluoropropylene-fluoropolymer (EFEP), are used.

Polyolefin films, such as polyethylene films or polypropylene films, are particularly suitable.

The carrier films preferably have a thickness of 5-700 μm, preferably 30-150 μm, particularly preferred 50-100 μm. The films may be blow-extruded or cast-extruded films.

An adhesion promoter layer is applied to the carrier film. The adhesion promoter layer is preferably applied directly to the carrier film. The adhesion promoter layer may consist of an aqueous lacquer system based on a self-crosslinking polymer and/or a polymer that can be crosslinked with hardener, for example based on a self-crosslinking polyurethane.

The lacquer system preferably has high barrier properties. In particular, the oxygen permeability according to DIN 53310-1 preferably amounts to 0.01-1 000 ccm³/m², more preferred to 0.05-100 ccm³/m², particularly preferred to 0.1-5 cm³/m².

The adhesion of the lacquer system preferably amounts to at least 4 N/15 mm. The following test process may be carried out for measuring:

On the film to be tested, an approx. 40 cm long piece of the prescribed Tesafilm is stuck to the left, center and right of the test sample transversely to the running direction and pressed down by hand. The Tesafilm is then pulled off the test sample at an angle of approx. 135°. If the test is passed, the adhesion of the lacquer system amounts to more than 4 N/15 mm.

According to the invention, the viscosity of the lacquer system is <200 mPas, preferably <20 mPas.

The lacquer layer acting as the adhesion promoter layer is applied using a grid in order to allow for a layer as homogeneous as possible.

Lattices of 160-300 lines/cm, in particular 200-260 lines/cm, have proved effective in this regard.

Anilox rollers, which ensure good flow of the lacquer layer, are particularly suitable for applying the lacquer layer. The lacquer layer may be applied with an anilox roller, for example, in an anilox co-flow or anilox counter-flow or in a line anilox co-flow or line anilox counter-flow or using a pressure chamber doctor blade. The variants mentioned above may also be operated in a kiss coating mode.

However, in addition and alternatively, other methods and aids, such as a Mayer rod (“Mayer Rod” or “Mayer Bar”) and/or nozzles, e.g. slot nozzles, etc., may be used to apply the lacquer layer.

The application thickness of this lacquer layer is preferably <3 g/m², preferably 0.8-1.2 g/m².

For drying the lacquer layer, preferably a ramp program is used, wherein a temperature sequence of 40-70° C.→90-120° C.→40-70° C. is set depending on the web speed and the lacquer used. In this regard, the web speed amounts to 1-500 m/min, preferably to 50 bis 250 m/min. The web tension during the drying process amounts to <50 daN/m, particularly preferred 7-16 daN/m, according to the invention.

Subsequently, the metallic layer is applied to the adhesion promoter layer. In this regard, the metallic layer is applied preferably directly to the adhesion promoter layer.

Suitable metallic layer are layers in particular made of Al, Cu, Ag, Au, Cr, Ni, Zn, Pd, V, In or Sn.

The metallic layer may preferably be deposited by PVD or CVD methods, for example by thermal evaporation, sputtering or electron beam evaporation.

The thickness of the metallic layer depends on the use of the metallized film and may amount to approx. 5-100 nm, preferably 10-70 nm, particularly preferred 20-50 nm.

If necessary, a cover layer may be applied to the metallic layer, which is readily printable. The cover layer preferably consists of a coating based on polyester, polyurethane or mixtures thereof, based on acrylates, for example ethylene acrylates. Such top layers are excellently printable by thermal transfer, offset, flexographic or inkjet printing and also with UV inks.

If necessary, the metal layer may also be printed directly.

1. A metallized film, in particular a metallized plastic film, which comprises a metallic layer on at least one surface, wherein it comprises the following layers in the indicated order:
a) a carrier substrate of a plastic film
b) a lacquer layer as an adhesion promoter layer
c) a metallic layer applied, in particular directly, to the lacquer layer
d) optionally a cover layer.

2. The metallized film according to claim 1, wherein the metallic layer comprises Al, Cu, Ag, Au, Cr, Ni, Zn, Pd, V, In or Sn.

3. The metallized film according to claim 1, wherein the metallic layer is applied by a PVD or CVD method.

4. The metallized film according to claim 1, wherein the carrier substrate comprises a flexible plastic film, which is made of one or multiple materials selected from the group of polyimide (PI), polypropylene (PP), monoaxially oriented polypropylene (MOPP), biaxially oriented polypropylene (BOPP), polyethylene (PE), polyphenylene sulfide (PPS), polyetheretherketone (PEEK), polyetherketone (PEK), polyethyleneimide (PEI), polysulfone (PSU), polyaryletherketone (PAEK), polyethylene naphthalate (PEN), liquid crystalline polymers (LCP), polyester, polybutylene terephthalate (PBT), polyethylene terephthalate (PET), polyamide (PA), polycarbonate (PC), cycloolefin copolymers (COC), polyoxymethylene (POM), acrylonitrile-butadiene-styrene (ABS), polyvinyl chloride (PVC) ethylene tetrafluoroethylene (ETFE), polytetrafluoroethylene (PTFE), polyvinyl fluoride (PVF), polyvinylidene fluoride (PVDF) and/or ethylene-tetrafluoroethylene-hexafluoropropylene-fluoropolymer (EFEP).

5. The metallized film according to claim 4, wherein the carrier substrate comprises polyethylene.

6. The metallized film according to claim 1, wherein the applied lacquer layer is structured based on a self-crosslinking polymer and/or a polymer that can be crosslinked with a hardener.

7. The metallized film according to claim 1, wherein the lacquer layer has 160-300 L/cm.

8. The metallized film according to claim 1, wherein the cover layer is structured on the basis of polyester, polyurethane or mixtures thereof, or on the basis of acrylates.

9. A method for producing the metallized film, according to claim 1, the method comprising the following method steps:
a) providing a carrier substrate made of a plastic film,
b) applying a lacquer layer made of a self-crosslinking polymer and/or a polymer that can be crosslinked with a hardener, with 160-300 L/cm,
c) drying the lacquer layer with a temperature sequence of 40-70° C.→90-120° C.→40-70° C. at a web speed of 1-500 m/min at a web tension of <50 daN/m,
d) applying a metallic layer, in particular directly, onto the lacquer layer by a PVD or CVD method, by thermal evaporation, sputtering or electron beam evaporation, and
e) optionally applying a cover layer.

10. The method according to claim 9, wherein the lacquer layer is applied in step c) by means of at least one anilox roller and/or at least one nozzle, in particular a slit nozzle, and/or at least one Mayer rod.
